(19) United States
(12) Patent Application Publication
(10) Pub. No.: US 2023/0115722 A1
(43) Pub. Date: Apr. 13, 2023

(54) STACKED TYPE POWER SUPPLY DEVICE

(71) Applicant: YAZAKI CORPORATION, Tokyo (JP)

(72) Inventors: Michihiro Ishihara, Makinohara-shi (JP); Yasuhiro Tanaka, Makinohara-shi (JP)

(21) Appl. No.: 17/960,795

(22) Filed: Oct. 5, 2022

(30) Foreign Application Priority Data
Oct. 13, 2021 (JP) 2021-168231

(51) Int. Cl. H01M 50/502; H01M 50/209

(52) U.S. Cl. CPC H01M 50/502; H01M 50/209

(57) ABSTRACT

A stacked type power supply device includes a first battery stack and a second battery stack in which a plurality of battery cells are stacked on each other, a first case and a second case in which the first battery stack and the second battery stack is accommodated respectively, a first connector electrically connected to the first battery stack and disposed to be exposed at a first opening provided in the first case, and a second connector electrically connected to the second battery stack and disposed to be exposed at a second opening provided in the second case. The first case and the second case are stacked on each other in a vertical direction, the first connector and the second connector are fitted to each other through the first and second openings, and the first battery stack and the second battery stack are electrically connected to each other.

### CROSS-REFERENCE TO RELATED APPLICATIONS

This application is based on and claims priority under 35 USC 119 from Japanese Patent Application No. 2021-168231 filed on Oct. 13, 2021, the contents of which are incorporated herein by reference.

### TECHNICAL FIELD

The presently disclosed subject matter relates to a stacked type power supply device in which a plurality of battery stacks are stacked on each other in a vertical direction.

### BACKGROUND ART

In the relate art, as a power supply for driving an electric vehicle or a hybrid vehicle, there are cases where a power supply device incorporating a battery stack in which a plurality of battery cells are stacked is used. In one power supply device in the relate art, cases accommodating battery stacks are stacked in a vertical direction, and the battery stacks are connected via a dedicated cable as disclosed, for example, in JP2015-088312A.

The above power supply device in the relate art requires not only stacking of the cases, but also connection of cables to the battery stacks. Physically thick electric wires are generally used for cables for connecting high-voltage battery stacks, such as drive power supplies. Therefore, it is difficult to route the cable within a narrow range while connecting the stacked cases, and it is difficult to improve workability of connecting the battery stacks. That is, there is room for improvement in productivity for the power supply device.

### SUMMARY

An object of the present disclosure provides a stacked type power supply device easy to be produced.

In order to achieve the above object, a stacked type power supply device according to the present disclosure is characterized as follows.

According to the present disclosure, a stacked type power supply device includes a first battery stack in which a plurality of first battery cells are stacked on each other in a stacking direction, a first case in which the first battery stack is accommodated, a first connector electrically connected to the first battery stack and disposed to be exposed at a first opening provided in the first case, a second battery stack in which a plurality of second battery cells are stacked on each other in the stacking direction, a second case in which the second battery stack is accommodated, and a second connector electrically connected to the second battery stack and disposed to be exposed at a second opening provided in the second case. The first case and the second case are configured to be stacked on each other in a vertical direction intersecting the stacking direction, the first connector and the second connector are configured to be fitted to each other through the first and second openings, and the first battery stack and the second battery stack are configured to be electrically connected to each other.

The present disclosure has been briefly described as above. Details of the present disclosure will be further clarified by reading through a mode for carrying out the disclosure described below with reference to the accompanying drawings.

### BRIEF DESCRIPTION OF DRAWINGS

FIG. 1 is a perspective side view of an inside of a stacked type power supply device according to an embodiment of the present disclosure;

FIG. 2 is a perspective top view of an inside of an upper battery pack shown in FIG. 1;

FIG. 3 is a perspective top view of an inside of a lower battery pack shown in FIG. 1; and

FIG. 4 is a view (a part thereof is a side view) showing main portions on a cross section along A-A in FIG. 1.

### DESCRIPTION OF EMBODIMENTS

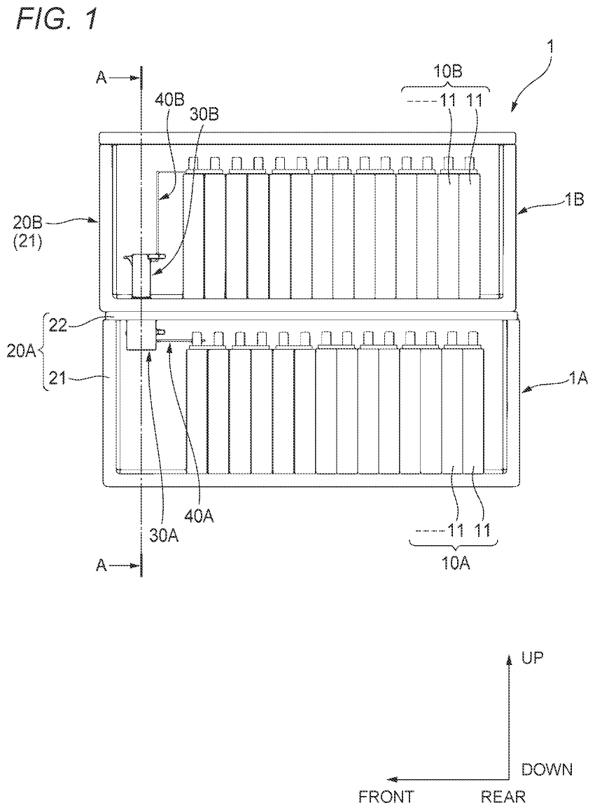

Hereinafter, a stacked type power supply device 1 according to an embodiment of the present disclosure will be described with reference to the drawings. As shown in FIG. 1, the power supply device 1 is formed by stacking an upper battery pack 1B on a lower battery pack 1A. The power supply device 1 is typically mounted on a hybrid vehicle or an electric vehicle and used as a power supply for the vehicle.

Hereinafter, for convenience of description, a “front-rear direction”, an “up-down direction”, and a “left-right direction” are defined, as shown in FIG. 1 to FIG. 4. The “front-rear direction”, the “up-down direction”, and the “left-right direction” are orthogonal to one another. The “up-down direction” coincides with a stacking direction of the lower battery pack 1A and the upper battery pack 1B, and the “front-rear direction” corresponds to a stacking direction of a plurality of battery cells 11 that constitute each of battery stacks 10A and 10B, which will be described later. Hereinafter, a configuration of the lower battery pack 1A and a configuration of the upper battery pack 1B that constitute the power supply device 1 will be described in order.

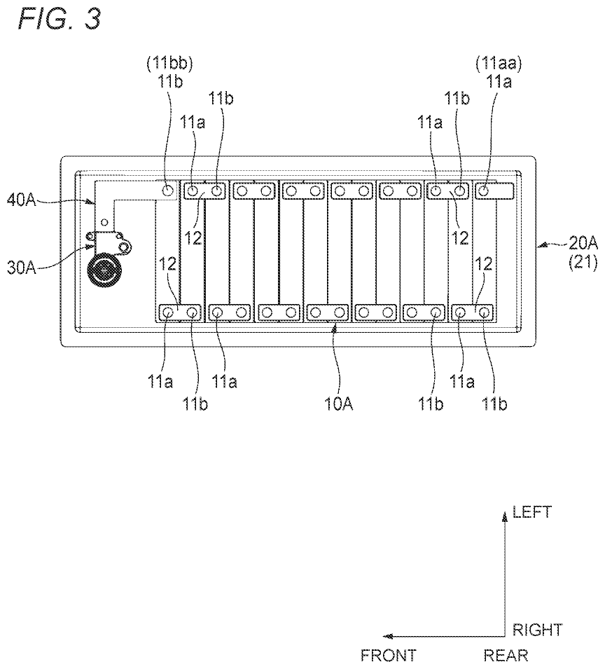

First, the configuration of the lower battery pack 1A will be described. As shown in FIG. 1 and FIG. 3, the lower battery pack 1A includes the battery stack 10A, and a case 20A in which the battery stack 10A is accommodated. The battery stack 10A is formed by stacking a plurality of battery cells 11. Each of the battery cells 11 is typically a secondary battery such as a nickel-metal hydride battery or a lithium-ion battery.

The battery cell 11 has a rectangular flat plate shape extending in the up-down direction and the left-right direction. A positive electrode terminal 11a and a negative electrode terminal 11b are respectively provided at one end and the other end in the left-right direction on an upper surface of the battery cell 11. In the battery stack 10A in this example, as shown in FIG. 3, a plurality of battery cells 11 with positive electrode terminals 11a on a left side and a plurality of battery cells 11 with negative electrode terminals 11b on the left side are alternately stacked in the front-rear direction, which are fixed to each other by predetermined fixing means (not shown).

In the battery stack 10A, for each of a plurality of “a pair of battery cells 1I adjacent in the front-rear direction”, the positive electrode terminal 11a of the battery cell 11 on a front side and the negative electrode terminal 11b of the battery cell 11 on a rear side are electrically connected to each other via a metal bus bar 12. As a result, in the battery stack 10A, a plurality of battery cells 11 are electrically connected in series, and a total negative electrode 11bb and a total positive electrode 11aa are located at a front end and a rear end of the battery stack 10A, respectively.

The case 20A is made of a metal, and, as shown in FIG. 1, includes a rectangular parallelepiped case body 21 extending in the front-rear direction and opening upward and a rectangular plate-shaped lid 22 closing an upper end opening of the case body 21. The battery stack 10A is accommodated in the case body 21. More specifically, the battery stack 10A is placed and fixed on a bottom wall of the case body 21 such that a predetermined space is ensured in a front region in an internal space of the case body 21.

As shown in FIG. 1 and FIG. 3, a connector 30A is fixed to the case body 21 so as to be positioned in an upper portion in the predetermined space. A fitting opening (not shown) opening upward is formed in an upper portion of the connector 30A, and a metal terminal (a male terminal or a female terminal; not shown) facing upward is accommodated in the connector 30A in a manner of facing the fitting opening.

As shown in FIG. 1 and FIG. 3, a terminal of the connector 30A and the total negative electrode 11bb of the battery stack 10A are electrically connected to each other inside the case body 21 via a metal plate-shaped conductive member 40A. The conductive member 40A is formed, for example, by pressing one metal plate.

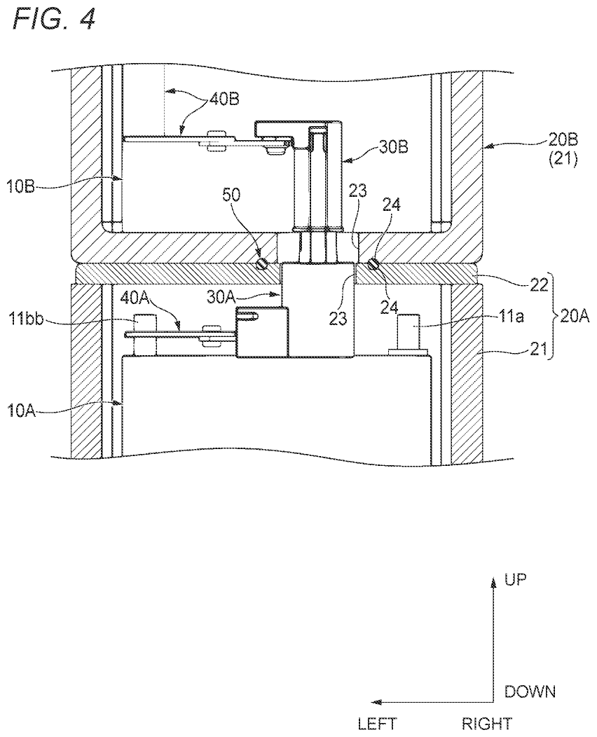

As shown in FIG. 4, the lid 22 is formed with an opening 23 penetrating the up-down direction corresponding to (the fitting opening of) the connector 30A. An annular O-ring groove 24 is formed around the opening 23 on an upper surface of the lid 22 so as to surround the opening 23. An O-ring 50 (see FIG. 4) is accommodated in the O-ring groove 24.

The lid 22 is attached to the case body 21 so as to close the upper end opening of the case body 21 in which the battery stack 10A, the connector 30A, and the conductive member 40A are accommodated. The case body 21 and the lid 22 are fixed to each other by predetermined fixing means (not shown). When the lid 22 is completely attached to the case body 21, the connector 30A (the fitting opening thereof) is exposed at the opening 23 formed in the lid 22, as shown in FIG. 4. The configuration of the lower battery pack 1A has been described above.

Next, the configuration of the upper battery pack 1B will be described. The configuration of the upper battery pack 1B is similar to the configuration of the lower battery pack 1A. In FIG. 1 to FIG. 4, members constituting the upper battery pack 1B having the functions same as those of the members constituting the lower battery pack 1A are denoted by the same reference numerals as those of the lower battery pack 1A (for members with “A” at the end of the reference numeral, “B” is added at the end of the reference numeral instead of “A”).

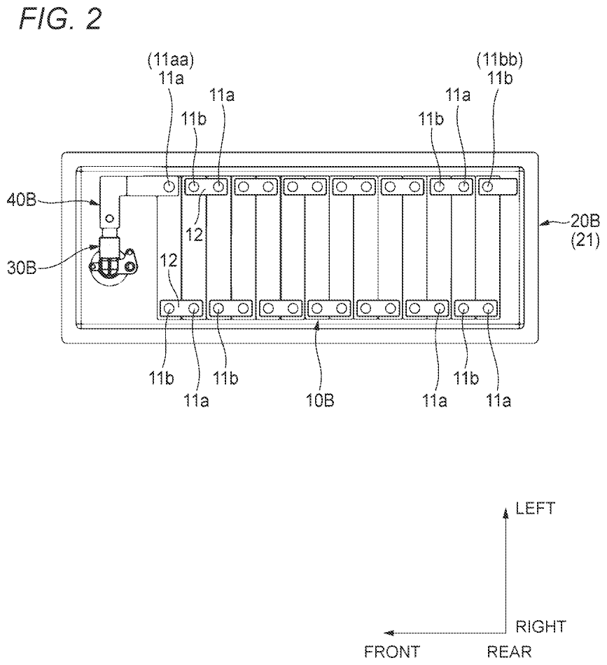

As shown in FIG. 1 and FIG. 2, the upper battery pack 1B includes the battery stack 10B, and a case 20B in which the battery stack 10B is accommodated. Since the configuration of the battery stack 10B is the same as the configuration of the battery stack 10A, detailed description thereof will be omitted. In the battery stack 10B in this example, as shown in FIG. 2, for each of a plurality of “a pair of battery cells 11 adjacent in the front-rear direction”, the negative electrode terminal 11b of the battery cell 11 on a front side and the positive electrode terminal 11a of the battery cell 11 on a rear side are electrically connected to each other via the metal bus bar 12. As a result, in the battery stack 10B, contrary to the battery stack 10A, the total positive electrode 11aa and the total negative electrode 11bb are positioned at a front end and a rear end of the battery stack 10B, respectively.

The case 20B is made of a metal, and, similar to the case 20A, incudes a rectangular parallelepiped case body 21 (see FIG. 1) extending in the front-rear direction and opening upward and a rectangular plate-shaped lid closing an upper end opening of the case body 21.

The battery stack 10B is accommodated in the case body 21 of the case 20B. More specifically, the battery stack 10B is placed and fixed on a bottom wall of the case body 21 such that a predetermined space is ensured in a front region in an internal space of the case body 21 of the case 20B.

As shown in FIG. 4, the bottom wall of the case body 21 of the case 20B is formed with an opening 23 penetrating the up-down direction corresponding to the opening 23 of the case 20A (lid 22). Corresponding to the O-ring groove 24 of the case 20A, an annular O-ring groove 24 is formed around the opening 23 on a lower surface of the bottom wall of the case 20B (case body 21) so as to surround the opening 23 of the case 20B.

As shown in FIG. 1 and FIG. 2, a connector 30B is fixed to the case body 21 of the case 20B so as to be positioned in a lower portion in the predetermined space. A fitting opening (not shown) opening downward is formed in a lower portion of the connector 30B, and a metal terminal (a female terminal or a male terminal; not shown) facing downward is accommodated in the connector 30B in a manner of facing the fitting opening. The connector 30B (the fitting opening thereof) is exposed at the opening 23 of the case 20B.

As shown in FIG. 1 and FIG. 2, a terminal of the connector 30B and the total positive electrode 11aa of the battery stack 10B are electrically connected to each other inside the case body 21 of the case 20B via a metal plate-shaped conductive member 40B. The conductive member 40B is formed, for example, by pressing one metal plate. The configuration of the upper battery pack 1B has been described above.

As described above, as shown in FIG. 4, in the lower battery pack 1A, the connector 30A connected to the total negative electrode 11bb of the battery stack 10A is disposed to be exposed at the opening 23 provided in the upper portion of the case 20A in which the battery stack 10A is accommodated, and in the upper battery pack 1B, the connector 30B connected to the total positive electrode 11aa of the battery stack 10B is disposed to be exposed at the opening 23 provided in the lower portion of the case 20B in which the battery stack 10B is accommodated.

The assembly of the stacked type power supply device 1 is completed by only stacking the upper battery pack 1B on the lower battery pack 1A in which the O-ring 50 (see FIG. 4) is accommodated in the O-ring groove 24, and fixing the lower battery pack 1A and the upper battery pack 1B to each other by a predetermined fixing means (not shown) (see FIG. 1).

When the assembly of the power supply device 1 is completed, the openings 23 of the lower battery pack 1A and the upper battery pack 1B are in communication with each other in the up-down direction, and the connector 30A and the connector 30B are fitted to each other through the communicating openings 23. Accordingly, the terminals of the connector 30A and the connector 30B are electrically connected to each other, whereby the battery stack 10A and the battery stack 10B are electrically connected in series. Further, the O-ring grooves 24 of the lower battery pack 1A and the upper battery pack 1B are disposed to be aligned in the up-down direction and press and hold the O-ring 50 in the up-down direction, whereby waterproofing can be achieved at a fitting portion between the connector 30A and the connector 30B.

According to the stacked type power supply device 1 of the present embodiment described above, the connector 30A is disposed to be exposed at the opening 23 of the case 20A in which the battery stack 10A is accommodated, and the connector 30B is disposed to be exposed at the opening 23 of the case 20B in which the battery stack 10B is accommodated. In addition, when the case 20A and the case 20B are stacked with each other, the openings 23 are in communication with each other, and the connector 30A and the connector 30B are fitted to each other through the communicating openings 23 to connect the battery stack 10A and the battery stack 10B. In this way, the battery stack 10A and the battery stack 10B can be electrically connected to each other simply by stacking the case 20A and the case 20B without requiring a dedicated cable as in the power supply device in the related art. That is, the work of stacking the case 20A and the case 20B and the work of connecting the battery stack 10A and the battery stack 10B can be performed collectively. Therefore, the power supply device 1 according to the present embodiment can be easily produced as compared with the power supply device in the related art.

Further, based on the disposition of the connector 30A, the battery stack 10A is disposed by stacking the battery cells 11 in a direction away from the connector 30A (toward the rear), and based on the disposition of the connector 30B, the battery stack 10B is disposed by stacking the battery cells 11 in a direction away from the connector 30B (toward the rear). Accordingly, the disposition of each of the battery stacks 10A and 10B can be rationalized, and the size of the power supply device 1 can be reduced.

Further, the O-ring 50 is disposed to surround the communication portion of the openings 23 of the case 20A and the case 20B. Accordingly, waterproofing can be achieved at the fitting portion between the connector 30A and the connector 30B without requiring a waterproof connector or the like having a complicated structure.

The present disclosure is not limited to the above embodiments, and various modifications can be adopted within the scope of the present disclosure. For example, the present disclosure is not limited to the above-described embodiment, and modifications, improvements, and the like can be made as appropriate. In addition, materials, shapes, dimensions, numbers, arrangement portions, and the like of components in the above-described embodiment are optional and not limited as long as the present disclosure can be achieved.

In the above embodiment, in the lower battery pack 1A, the total negative electrode 11bb of the battery stack 10A and the connector 30A are connected to each other via the conductive member 40A, and in the upper battery pack 1B, the total positive electrode 11aa of the battery stack 10B and the connector 30B are connected to each other via the conductive member 40B. In contrast, in the lower battery pack 1A, the total positive electrode 11aa of the battery stack 10A and the connector 30A may be connected to each other via the conductive member 40A, and in the upper battery pack 1B, the total negative electrode 11bb of the battery stack 10B and the connector 30B may be connected to each other via the conductive member 40B.

Further, in the above embodiment, an annular seal member (O-ring 50) is disposed to surround the communication portion of the opening 23 of the case 20A in the lower battery pack 1A and the opening 23 of the case 20B in the upper battery pack 1B. In contrast, such an annular seal member may not be disposed. In this case, the O-ring groove 24 (see FIG. 4) provided in each of the cases 20A and 20B can be omitted.

Here, characteristics of the embodiment of the power supply device 1 according to the present disclosure described above are summarized briefly in the following first to third aspects.

According to a first aspect of the present disclosure, a stacked type power supply device (1) includes a first battery stack (10A) in which a plurality of first battery cells (11) are stacked on each other in a stacking direction, a first case (20A) in which the first battery stack (10A) is accommodated, a first connector (30A) electrically connected to the first battery stack (10A) and disposed to be exposed at a first opening (23) provided in the first case (20A), a second battery stack (10B) in which a plurality of second battery cells (11) are stacked on each other in the stacking direction, a second case (20B) in which the second battery stack (10B) is accommodated, and a second connector (30B) electrically connected to the second battery stack (10B) and disposed to be exposed at a second opening (23) provided in the second case (20B). The first case (20A) and the second case (20B) are configured to be stacked on each other in a vertical direction intersecting the stacking direction, the first connector (30A) and the second connector (30B) are configured to be fitted to each other through the first and second openings (23), and the first battery stack (10A) and the second battery stack (10B) are configured to be electrically connected to each other.

According to the stacked type power supply device with the above first aspect, the first connector is disposed to be exposed at the opening of the first case in which the first battery stack is accommodated, and the second connector is disposed to be exposed at the opening of the second case in which the second battery stack is accommodated. In addition, when the first case and the second case are stacked with each other, the openings are in communication with each other, and the first connector and the second connector are fitted to each other through the communicating openings to connect the first battery stack and the second battery stack. In this way, the battery stacks can be electrically connected to each other simply by stacking the first case and the second case without requiring a dedicated cable as in the power supply device in the related art. That is, the stacking work and the work of connecting the battery stacks can be performed collectively. Therefore, the power supply device with this configuration is easier to produce than the power supply device in the related art.

According to a second aspect of the present disclosure, the first connector (30A) is connected to a first total positive electrode (11aa) of the first battery stack (10A) and the second connector (30B) is connected to a second total negative electrode (11bb) of the second battery stack (10B), or the first connector (30A) is connected to a first total negative electrode (11bb) of the first battery stack (10A) and the second connector (30B) is connected to a second total positive electrode (11aa) of the second battery stack (10B). The plurality of first battery cells (11) are sequentially stacked on each other in a direction away from the first connector (30A). The plurality of second battery cells (11) are sequentially stacked on each other in a direction away from the second connector (30B).

According to the stacked type power supply device with the above second aspect, based on the disposition of the first connector, the battery cells are stacked in a direction away from the first connector, and based on the disposition of the second connector, the battery cells are stacked in a direction away from the second connector. Accordingly, the disposition of the battery stacks or the stacking direction of the battery cells can be rationalized, and the size of the power supply device can be reduced.

According to a third aspect of the present disclosure, the stacked type power supply device (1) further includes an annular seal member (50) disposed to surround a communication portion of the first and second openings (23).

According to the stacked type power supply device with the above third aspect, the seal member (for example, packing) is disposed to surround the communication portion of the openings. Accordingly, waterproofing can be achieved at the fitting portion between the first connector and the second connector without requiring a waterproof connector or the like having a complicated structure.

What is claimed is:

1. A stacked type power supply device comprising:
a first battery stack in which a plurality of first battery cells are stacked on each other in a stacking direction;
a first case in which the first battery stack is accommodated;
a first connector electrically connected to the first battery stack and disposed to be exposed at a first opening provided in the first case;
a second battery stack in which a plurality of second battery cells are stacked on each other in the stacking direction;
a second case in which the second battery stack is accommodated; and
a second connector electrically connected to the second battery stack and disposed to be exposed at a second opening provided in the second case, wherein
the first case and the second case are configured to be stacked on each other in a vertical direction intersecting the stacking direction, the first connector and the second connector are configured to be fitted to each other through the first and second openings, and the first battery stack and the second battery stack are configured to be electrically connected to each other.

2. The stacked type power supply device according to claim 1, wherein
the first connector is connected to a first total positive electrode of the first battery stack and the second connector is connected to a second total negative electrode of the second battery stack, or the first connector is connected to a first total negative electrode of the first battery stack and the second connector is connected to a second total positive electrode of the second battery stack,
the plurality of first battery cells are sequentially stacked on each other in a direction away from the first connector, and
the plurality of second battery cells are sequentially stacked on each other in a direction away from the second connector.

3. The stacked type power supply device according to claim 1, further comprising:
an annular seal member disposed to surround a communication portion of the first and second openings.
